(19) United States
(12) Patent Application Publication
(10) Pub. No.: US 2019/0253371 A1
(43) Pub. Date: Aug. 15, 2019

(54) SYSTEMS AND METHODS FOR SHARING CAPTURED VISUAL CONTENT

(71) Applicant: GoPro, Inc., San Mateo, CA (US)

(72) Inventors: Ian Miller, San Diego, CA (US); Jason Short, Oakland, CA (US); Nicholas Ryan Gilmour, San Jose, CA (US); Priyanka Singh, San Jose, CA (US)

(21) Appl. No.: 15/799,422

(22) Filed: Oct. 31, 2017

(51) Int. Cl. H04L 12/58; G06F 3/16; H04W 4/08; G06F 3/0484; H04M 3/56; G06Q 50/00

(52) U.S. Cl. CPC H04L 51/10; G06F 3/167; G06Q 50/01; G06F 3/0484; H04M 3/567; H04W 4/08

(57) ABSTRACT

An image sensor may generate visual output signals conveying visual information. The visual information may define visual content based on light received within a field of view of the image sensor. A sound sensor may receive and convert sounds into sound output signals. A voice command to operate in a sharing mode may be detected based on the sound output signals. Operation in the sharing mode may cause visual content captured by the image sensor during operation in the sharing mode to be accessible to members of a sharing group. Operation outside the sharing mode may case visual content captured by the image sensor during operation outside the sharing mode to not be accessible to the members of the sharing group. The visual information defining the visual content captured by the image sensor during the operation in the sharing mode may be stored in shared storage media.

### FIELD

This disclosure relates to systems and methods for sharing captured visual content based on operation of a camera in a sharing mode.

### BACKGROUND

Multiple people may capture visual content (images, videos) for a single event and/or related events. Manually sharing the visual content among multiple people may be difficult and/or time consuming,

### SUMMARY

This disclosure relates to sharing captured visual content, An image sensor may generate visual output signals conveying visual information. The visual information may define visual content based on light received within a field of view of the image sensor. A sound sensor may receive and convert sounds into sound output signals. A voice command to operate in a sharing mode may be detected based on the sound output signals. Operation in the sharing mode may cause visual content captured by the image sensor during operation in the sharing mode to be accessible to members of a sharing group. Operation outside the sharing mode may case visual content captured by the image sensor during operation outside the sharing mode to not be accessible to the members of the sharing group. The visual information defining the visual content captured by the image sensor during the operation in the sharing mode may be stored in shared storage media.

A system that facilitates sharing of captured visual content may include one or more of an image sensor, a sound sensor, a processor, and/or other components. An image sensor may be configured to generate visual output signals conveying visual information. The visual information may defining visual content based on light received within a field of view of the image sensor. A sound sensor ay be configured to receive and convert sounds into sound output signals. In some implementations, the system may further include one or more location sensors.

The processor(s) may be configured by machine-readable instructions. Executing the machine-readable instructions may cause the processor(s) to facilitate sharing captured visual content. The machine-readable instructions may include one or more computer program components. The computer program components may include one or more of a command component, an operation component, a storage component, and/or other computer program components.

The command component may be configured to detect one or more voice commands to operate in a sharing mode based on the sound output signals and/or other information. The command component may be configured to detect one or more stop commands to stop the operation in the sharing mode. In some implementations, a stop command may be detected based on the sound output signals and/or other information.

The operation component may be configured to operate in the sharing mode based on a voice command to operate in the sharing mode and/or other information. Operation in the sharing mode may cause visual content captured by the image sensor during the operation in the sharing mode to be accessible to members of a sharing group.

The operation component may be configured to operate outside the sharing mode. In some implementations, the operation component may stop the operation in the sharing mode based on a voice command to stop the operation in the sharing mode and/or other information. Operation outside the sharing mode may cause visual content captured by the image sensor during the operation outside the sharing mode to not be accessible to the members of the sharing group. The visual information defining the visual content captured by the image sensor during the operation in the sharing mode may be accessible by the members of the sharing group who have stopped the operation in the sharing mode.

In some implementations, the access of the visual information defining the visual content captured by the image sensor during the operation in the sharing mode by the members of the sharing group may be limited based on a type of the visual content and/or other information. In some implementations, the type of the visual content may include an image type, a video type, and/or other visual types.

In some implementations, the sharing group may be determined based on an audio fingerprint of the voice command and/or other information. In some implementations, the sharing group may be determined based on a location and a time of the voice command and/or other information. In some implementations, the sharing group may be determined further based on proximity of the location and the time of the voice command to locations and times of the voice command associated with others of the members of the sharing group, and/or other information.

In some implementations, the location of the voice command may be determined based on outputs of the location sensor(s) included within the system. In some implementations, one or more locations sensors may be included within a mobile device. The processor(s) may be further configured by the machine-readable instructions to communicate with the mobile device, and the location of the voice command may be determined based on outputs of the location sensor(s) included within the mobile device.

The storage component may be configured to effectuate storage of the visual information defining the visual content captured by the image sensor during the operation in the sharing mode in shared storage media.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for sharing captured visual content.

FIG. 2 illustrates a method for sharing captured visual content.

FIG. 3A illustrates an example scenario for sharing captured visual content.

FIG. 3B illustrates an example scenario for sharing captured visual content.

FIG. 4 illustrates an example user interface for sharing captured visual content.

### DETAILED DESCRIPTION

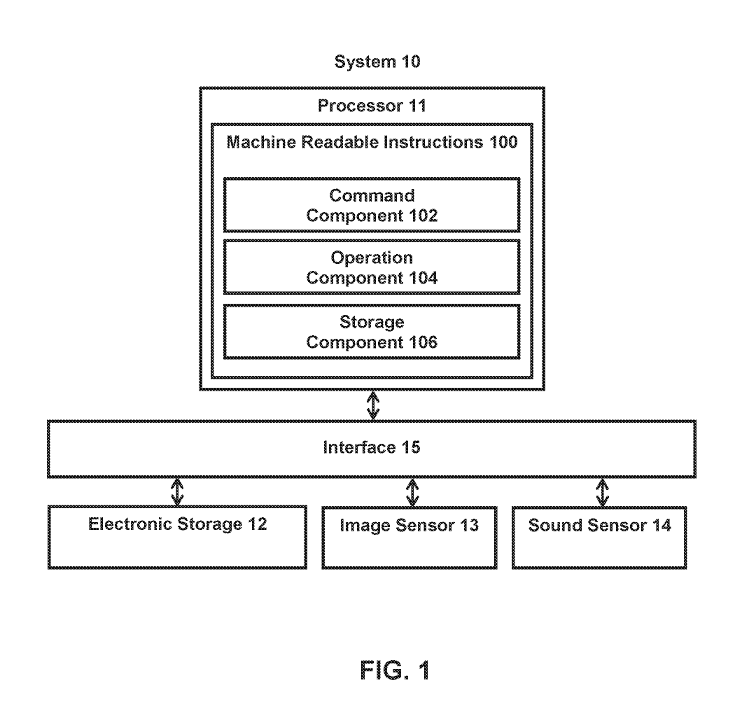

FIG. 1 illustrates system 10 for sharing captured visual content. System 10 may include one or more of a processor 11, an electronic storage 12, an image sensor 13, a sound sensor 14, an interface 15 (e.g., bus, wireless interface), and/or other components. The image sensor 13 may generate visual output signals conveying visual information. The visual information may define visual content based on light received within a field of view of the image sensor 13. The sound sensor 14 may receive and convert sounds into sound output signals. A voice command to operate in a sharing mode may be detected by the processor 11 based on the sound output signals. Operation of the processor 11/the system 10 in the sharing mode may cause visual content captured by the image sensor 13 during operation in the sharing mode to be accessible to members of a sharing group. Operation of the processor 11/the system 10 outside the sharing mode may case visual content captured by the image sensor 13 during operation outside the sharing mode to not be accessible to the members of the sharing group. The visual information defining the visual content captured by the image sensor during the operation in the sharing mode may be stored in shared storage media.

The electronic storage 12 may be configured to include electronic storage medium that electronically stores information. The electronic storage 12 may store software algorithms, information determined by processor 11, information received remotely, and/or other information that enables system 10 to function properly. For example, the electronic storage 12 may store information relating to image sensor, visual information, storage of visual information, sound sensor, sound, converting sound, voice command, sharing mode, non-sharing mode, shared storage media, and/or other information.

The image sensor 13 may be configured to generate visual output signals conveying visual information and/or other information. The visual information may define visual content (e.g., images, videos) based on light received within a field of view of the image sensor 13. The image sensor 13 may include one or more image sensors (e.g., a charge-coupled device sensor, an active pixel sensor, a complementary metal-oxide semiconductor sensor, an N-type metal-oxide-semiconductor sensor). The field of view of the image sensor 13 may be defined by one or more optical elements (e.g., lens) that receives light and directs the received light onto the image sensor 13.

The sound sensor 14 (e.g., microphone) may be configured to receive and convert sounds into sound output signals. For example, the sound sensor 14 may include a microphone that receives and converts sounds into sound output signals. The sound output signals may convey sound information and/or other information. The sound information may define audio content in one or more formats, such as WAV, MP3, MP4, RAW. The sound information may be stored in one or more locations, such as the electronic storage 12, storage of the sound sensor, remote storage, and/or other locations. In some implementations, the sound sensor 14 may be included within the same housing that carries the processor 11 and/or the image sensor 13. In some implementations, the sound sensor 14 may be/included in a separate device from a device including the processor 11 and/or the image sensor 13. In some implementations, the sound sensor 14 may be remotely coupled to the processor 11/image sensor 13 (e.g., the device including the sound sensor 14 may be coupled to the device including the processor 11/image sensor 13).

Referring to FIG. 1, processor 11 may be configured to provide information processing capabilities in system 10. As such, processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. Processor 11 may be configured to execute one or more machine readable instructions 100 to facilitate sharing captured visual content. Machine readable instructions 100 may include one or more computer program components. Machine readable instructions 100 may include one or more of a command component 102, an operation component 104, a storage component 106, and/or other computer program components.

The command component 102 may be configured to detect one or more voice commands to operate in a sharing mode based on the sound output signals and/or other information. The command component 102 may analyze the sound output signals and/or the sound information to determine whether one or more voice commands have been spoken near the system 10. The voice command(s) to operate in the sharing mode may be received at a particular time and at a particular location. The voice command(s) to operate in the sharing mode may include one or more particular terms, one or more combinations of terms, and/or other voice commands. For example, a voice command to operate in the sharing mode may include the terms “Start Party Mode,” and/or other words/terms.

In some implementations, the command component 102 may perform voice recognition to determine that the voice of the voice command(s) corresponds to an authorized user—that is, only specific person(s) may be authorized to give the voice command(s) to operate in the sharing mode and the command component 102 may determine whether the voice command(s) were given by an authorized user. In some implementations, different authorized users may have different voice commands (different terms/combination of terms to operate in the sharing mode).

In some implementations, the command component 102 may require the voice command(s) to be received at a certain volume (e.g., certain decibel). Requiring a certain volume for the voice command may increase the likelihood that the voice command detected corresponds to the actual term(s) spoken (e.g., reduce false detection of voice commands). Requiring a certain volume for the voice command may require the system 10/the sound sensor 14 to be proximate to the source of the voice command for proper voice command detection.

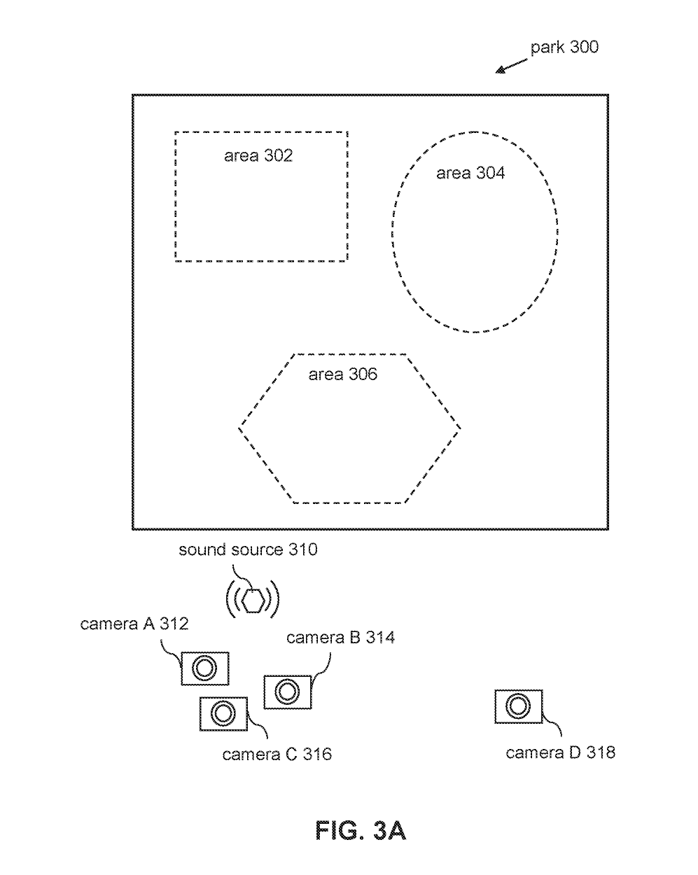

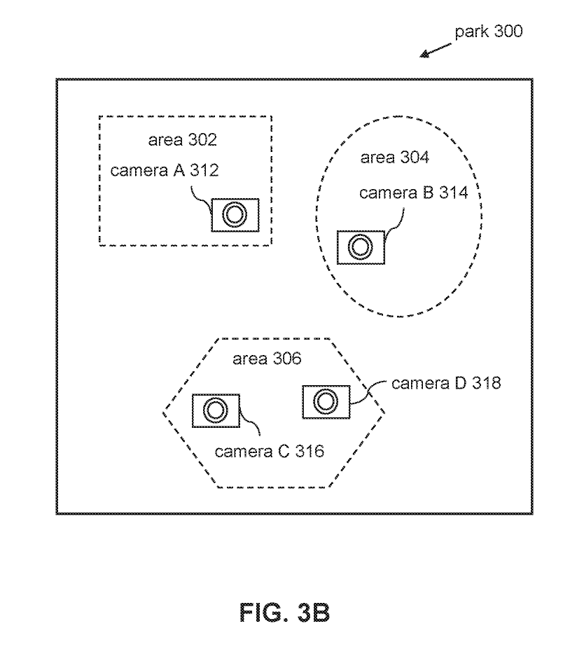

For example, FIG. 3A illustrates an example scenario for sharing captured visual content. In FIG. 3A, a camera A 312, a camera B 314, a camera C 316, and a camera D 318 may be outside of a park 300 (which includes areas 302, 304, 306). The camera A 312, the camera B 314, the camera C 316, and the camera D 318 may individually include processor(s), image sensor(s), sound sensors, and/or other components of system 10. The command component 102 of the camera A 312, the camera B 314, and the camera C 316 may detect one or more voice commands to operate in a sharing mode based on sound originating from a sound source 310 (e.g., a person speaking the voice command(s)). For example, the command component 102 of the cameras 312, 314, 316 may detect the same voice command spoken by the sound source 310. The command component 102 of the camera D 318 may not detect the voice command detected by the command component 102 of the camera's 312, 314, 316 (e.g., because of distance and/or one or more barriers between the location of the sound source 310 and the location of the camera D 318).

The command component 102 may be configured to detect one or more stop commands to stop the operation in the sharing mode (e.g., commands to operate in a non-sharing mode). The stop command(s) may include a voice command (e.g., one or more particular terms, one or more combinations of terms, and/or other voice commands) and/or other user input (received via one or more physical/digital button presses, ones or more interactions with a touchscreen interface). For example, a stop command may be detected based on a user's interaction with an stop button displayed on a display coupled to the processor 11 (e.g., a display of the camera C 316, a display of a mobile device paired with the camera C 316) and/or other information. The stop command(s) may be detected based on the sound output signals and/or other information. The stop command(s) may be detected based on analysis of the sound output signals and/or the sound information to determine whether one or more stop voice commands have been spoken near the system 10. For example, a stop voice command may include the terms “Stop Party Mode,” and/or other words/terms.

In some implementations, the command component 102 may require the stop voice command(s) to be received from the same person that gave the voice command to operate in the sharing mode. In some implementations, the command component 102 may require the stop voice command(s) to be received at a certain volume. In some implementations, the command component 102 may require the stop voice command to be received from an authorized user. In some implementations, different authorized users may have different stop voice commands.

For example, FIG. 3B illustrates an example scenario for sharing captured visual content. FIG. 3B may show the locations of the cameras 312, 314, 316, 318 in the park 300 subsequent to the locations of the cameras 312, 314, 316, 318 shown in FIG. 3A. That is, after the voice command(s) to operate in the sharing mode was given by the sound source 310 in FIG. 3A, the users of the cameras 312, 314, 316, 318 may have entered the park 300 and visited different areas 302, 304, 306 within the park 300. Referring to FIG. 3B, one or more of the command components 102 of the cameras 312, 314, 316 may detect one or more stop commands to stop the operation in the sharing mode. For example, the command component 102 of the camera C 316 may detect a stop command to stop operation in the sharing mode while located in the area 306.

In some implementations, stopping the operation in the sharing mode may be reversible. The command component 102 may be configured to enable operation in the sharing mode after a previous operation in the sharing mode has been stopped—that is, the command component 102 may be configured to re-enable/continue prior operation in the sharing mode. In some implementations, only certain person(s) (e.g., administrative user(s)/account(s)) may be authorized to re-enable/continue prior operation in the sharing mode. In some implementations, the users/accounts authorized to re-enable/continue prior operation in the sharing mode may include users/accounts that enabled the initial operation in the sharing mode (e.g., the person that gave the original voice command to operate in the sharing mode).

The operation component 104 may be configured to operate (the processor 11/the system 10) in the sharing mode based on one or more voice commands to operate in the sharing mode and/or other information. Operation in the sharing mode may cause visual content (e.g., images, videos) captured by the image sensor 13 during the operation in the sharing mode to be accessible to members of a sharing group. A sharing group may refer to a particular grouping of members (e.g., users, accounts) that have access to visual content captured by image capture devices associated with the members of the particular group while the image capture devices are operating in the sharing mode.

In some implementations, image capture devices may include aerial image capture devices (e.g., operating in the air via drone, mechanical extension) and/or ground image capture devices (e.g., operating on the ground, such as carried by a person or a ground-operating device). Operation of aerial image capture device(s) and ground image capture device(s) may enable capture of same event/object/scene from different vantage points, and provide for alternative views of the same time-synchronized event/object/scene. In some implementations, one or more of the image capture devices may act as a master for a sharing group and initiate capture across multiple image capture devices that are within the sharing group (and time synchronized).

Connection between image capture devices and/or devices coupled to/operating in relation to the image capture devices may include direct connection and/or indirection connect. For example, a ground image capture device may communicate with an aerial image capture device, a device (e.g., drone, mechanical extension) carrying the aerial image capture device, and/or a controller for the device (e.g., remote control for the drone/mechanical extension) via direct communication connection and/or indirect communication connection. Such connection may enable a user of the ground image capture device to capture the same or different event/object/scene using the ground image capture device and the aerial image capture device (e.g., initiate capture by the aerial image capture device and the ground image capture device of the same/different subject).

Connection between a ground image capture device and a remote for a drone carrying an aerial image capture device may provide for increased range of connection. For example, the range of communication between the ground image capture device and the aerial image capture device/drone may include the range between the ground image capture device and the remote and the range between the remote and the aerial image capture device/drone. Connection between the ground image capture device and the aerial image capture device/drone/mechanical extension may allow for control of the aerial image capture device/drone/mechanical extension from/through the ground image capture device.

For example, referring to FIG. 3B, users of the cameras 312, 314, 316, 318 may have entered the park 300 and captured visual content while visiting different areas 302, 304, 306. Based on the voice command received/detected previously to entering the park 300 (e.g., as shown in FIG. 3A), the cameras 312, 314, 316 may be operating in the sharing mode. Based on their operation in the sharing mode, the visual content captured by the cameras 312, 314, 316 may be accessible to members of the sharing group. For example, the visual content captured by the camera A 312 while in the area 302 may be accessible to members of the sharing group (users, accounts associated with the cameras 312, 314, 316). The visual content captured by the camera B 304 while in the area 304 may be accessible to members of the sharing group (users, accounts associated with the cameras 312, 314, 316). The visual content captured by the camera C 306 while in the area 306 may be accessible to members of the sharing group (users, accounts associated with the cameras 312, 314, 316).

The visual content captured during operation in the sharing mode may be identified (e.g., marked, tagged) as shared visual content. For example, session information identifying one or more identifiers may be associated with the shared visual content (e.g., embedded within metadata for shared visual content). Session information may include one or more of session identifier, group identifier, user identifier, other identifiers, and/or other information.

Session identifier may include one or more unique identifiers with date information, time information, location information (if available), and/or other information. In some implementations, sessions of different sharing groups attending the same event may be provided as combined content, since the captured visual content may be specific to the event (rather than individuals that captured the visual content).

Group identifier may include one or more unique identifiers of the specific devices (e.g., image capture devices, mobile devices paired to image capture devices) and/or accounts/users included in a sharing group (at any one time). Tying to user accounts and/or devices may allow a user with multiple image capture devices to combine visual content captured by multiple image capture devices, as well as enabling different image capture device users to tie visual content (immediately) to their accounts (in the cloud). In some implementations, a new group identifier may be used as users/image capture devices are added or removed from a sharing group.

User identifier may include one or more unique identifier associating (e.g., tying) an image capture device to a user/account. A user that has/operates multiple image capture devices may associate them to a single account, but maintain the distinction between the visual content captured by the individual image capture devices.

Visual content may be organized/managed/sorted based on the session information and/or other information. For example, software (e.g., application providing interface for the visual content) and/or hardware (e.g., server storing/hosting the visual content) may use session information to organize shared visual content. Software and/or hardware may use session information to enable visual content creation that utilizes visual content of the same event/object/scene from different perspectives (e.g., captured by same or different image capture devices in the sharing group).

Session information may be used to provide category/content management to sort the visual content and organize them based on the sharing group and/or the event. Session information may enable users to consume (e.g., see, copy, modify) visual content from other users within the same sharing group and/or event. Session information may enable users to see other users within a similar event based on location, date, and/or time, and combine other users into a new sharing group. Session information may enable production of group edits that combine one or more elements of the same event into visual content including views from a variety of vantage points. Session information may be used to track which members of the sharing group have discontinued operation in the sharing mode/left the sharing group. Other uses of session information are contemplated.

In some implementations, session information may be used by a particular image capture device within the sharing group to act as a master for the group and initiate capture across multiple image capture devices (that are time synchronized). For example, an aerial/ground image capture device may initiate capture by other aerial image capture devices and/or ground image capture devices at the same time/location/event.

In some implementations, connected image capture devices within a group may be disconnected (e.g., due to being out of range of each other). Session information may enable disconnected image capture devices to identify shared visual content (e.g., apply identifying metadata to the visual content captured during operation in the sharing mode) so that the shared visual content may be accessed/combined. In some implementations, image capture devices within a sharing group may (periodically, frequently) synchronize their times.

In some implementations, the operation component 104 may prompt a user to confirm the operation in the sharing mode (e.g., via user input received via one or more physical/digital button presses, ones or more interactions with a touchscreen interface) before operating in the sharing mode. In some implementations, one or more users may be prompted to confirm the listing/identities of members in the sharing group. For example, certain users (e.g., administrative users/accounts) may be asked to confirm the listing/identities of members (e.g., users/accounts) in the sharing group. The user that enabled the operation in the sharing mode (e.g., the person that gave the voice command to operate in the sharing mode) may be asked to confirm the listing/identities of members (e.g., users/accounts) in the sharing group. Such confirmation of the sharing group may prevent the sharing group from including unintended members (e.g., users/accounts of devices that heard the voice command, but for which the voice command was not intended). Such confirmation of the sharing group may also allow users to confirm that all desired devices are operating in the sharing mode.

In some implementations, the sharing group may be fixed—the number and/or the identities of the members in the sharing group may not be changed once the sharing group is created. For example, a sharing group including users/accounts associated with the cameras 312, 314, 316 determined based on a voice command from the sound source 310 may be fixed and may not be changed.

In some implementations, the sharing group may be flexible—the number and/or the identities of the members in the sharing group may be changed after the sharing group is created. For example, a sharing group including users/accounts associated with the cameras 312, 314, 316 determined based on a voice command from the sound source 310 may be flexible and may be changed. For example, the user/account associated with the camera D 318 may be added to the sharing group. In some implementations, only certain person(s) (e.g., administrative user(s)/account(s)) may be authorized to change the sharing group (e.g., add the user/account associated with the camera D 318 to the sharing group). In some implementations, the users authorized to change the sharing group may include users that enabled the initial operation in the sharing mode (e.g., the person that gave the original voice command to operate in the sharing mode).

In some implementations, the sharing group may be determined based on a location and a time of the voice command and/or other information. For example, the number of members in the sharing group, the identities of members in the sharing group, and/or identifier of the sharing group may be determined based on the location and the time of the voice command and/or other information such that the sharing group includes those members whose devices (e.g., cameras, mobile devices paired to the cameras) received/detected a voice command to operate in the sharing mode at/near the same location (based on proximity of the locations at which the voice command was received/detected by the devices) and at/near the same time (based on proximity of the times at which the voice command was received/detected by the devices).

For example referring to FIG. 3A, the cameras 312, 314, 316 may receive/detect a voice command (from the sound source 310) to operate in the sharing mode. Based on the voice command, the cameras 312, 314, 316 (and/or mobile devices paired with the cameras 312, 314, 316) may log an event indicating the voice command to operate in the sharing mode. The location of the cameras 312, 314, 316 (and/or locations of the mobile devices paired with the cameras 312, 314, 316) when the voice command was received/detected may similarly be recorded (e.g., by the cameras, the mobile devices paired with the cameras 312, 314, 316). The combination of times and locations of the voice command received/detected in proximity to each other may be used to create an ad-hoc group of members who share captured visual content. Based on the proximity of times and location of the voice command detection, the identities of members who wish to share captured visual content may be determined.

Whether the voice command reception/detection was proximate enough (in time and/or location) to include a particular member in a sharing group may be determined based on one or more threshold values. Threshold values may include location threshold values defining the required proximity of locations of voice command reception/detection, time threshold values defining the required proximity of times of voice command reception/detection, and/or other threshold values. The threshold values may be determined based on system defaults (e.g., set values), user input (e.g., users are given control over how proximate in time and/or location the voice commands must be received/detected), and/or other information.

In some implementations, the location of the voice command may be determined based on outputs of the location sensor(s) included within the system 10. For example, referring to FIG. 3A, one or more of the cameras 312, 314, 316 may include location sensors (e.g., GPS) enabling such camera(s) and/or GPS system(s) communicating with such camera(s) to determine the locations of the camera(s). The location sensor output(s) of such camera(s) may be used to determine and record the location(s) of the cameras when the voice command was received/detected.

In some implementations, one or more locations sensors may be included within a mobile device. A mobile device may refer to a portable computing device. For example, a mobile device may include a smartphone, a tablet, a smartwatch, a laptop, and/or other mobile devices, One or more of the cameras 312, 314, 316 may be configured to communicate with the mobile device (e.g., paired with the mobile device through a neighbor area network and/or other networks). In some implementations, one or more functionalities of the system 10 (e.g., the command component 102, the operation component 104, and/or the storage component 106) may be performed by an image capture device, a mobile device paired to the image capture device, and/or by the image capture device and the mobile device operating in conjunction with each other.

The location of the voice command may be determined based on outputs of the location sensor(s) included within the mobile device. For example, one or more of the cameras 312, 314, 316 may not include location sensors, but the mobile device(s) paired to such camera(s) may include location sensor(s). A paired mobile device may provide location information of the paired camera to be used for sharing group determination.

In some implementations, the sharing group may be determined based on an audio fingerprint of the voice command and/or other information. An audio fingerprint may include a digital summary of one or more audio information/signal. An audio fingerprint may include/be identified by an identifier. For example, referring to FIG. 3A, an identifier/audio fingerprint may be generated from the audio waveform of the voice command spoken by the sound source 310. The identifier/audio fingerprint may be used to identify which of the cameras 312, 314, 316, 318 received the same voice command.

In some implementations, the audio fingerprint may replace one or both of the time and location of the voice command reception/detection for sharing group determination. That is the sharing group may be determined based on (1) the time of the voice command and the audio fingerprint, (2) the location of the voice command and the audio fingerprint, or (3) the audio fingerprint. The use of audio fingerprint may allow for a single factor sharing group determination that avoids issues such as clock offsets/drifts and/or lack of locations sensors in image capture devices. In some implementations, generation of audio finger print may include one or more application of filters and/or transformation of sound information into simpler representation of sound to compensate for different image capture devices receiving the voice command at different levels of audio, ambient sounds, and/or other forms of audio distortions.

In some implementations, the sharing group may be determined based on use of one or more shared unique identifications. For example, an image capture device (and/or a mobile device paired with the image capture device) may transmit (e.g., via BLE, WiFi) to other image capture devices (and/or other mobile devices paired with the other image capture devices) a unique identification of a sharing group/sharing mode. The users/accounts of devices with the unique identification may be included within the sharing group.

The operation component 104 may be configured to operate (the processor 11/the system 10) outside the sharing mode (e.g., in a non-sharing mode). The operation component 104 may stop the operation in the sharing mode based on user input (e.g., a voice command, user interaction with a physical/digital button) to stop the operation in the sharing mode and/or other information. In some implementations, the operation component 104 may prompt a user to confirm the operation outside the sharing mode (e.g., user input received via one or more physical/digital button presses, ones or more interactions with a touchscreen interface) before operating outside the sharing mode/stopping operation of the sharing mode.

Operation outside the sharing mode may cause visual content captured by the image sensor 13 during the operation outside the sharing mode to not be accessible to the members of the sharing group. For example, referring to FIG. 3B, based on not receiving/detecting the voice command from the sound source 310 (shown in FIG. 3A) previously to entering the park 300, the camera D 318 may not be operating in the sharing mode. Based on its operation outside the sharing mode, the visual content captured by the camera D 318 may not be accessible to members of the sharing group (users, accounts associated with the cameras 312, 314, 316).

As another example, the camera C 316 may have received/detected, while in the area 306 (as shown in FIG. 3B), a stop command to stop operating in the sharing mode. Based on the stop command, the camera C 316 may stop its operation in the sharing mode and the visual content captured by the camera C 316 after it stopped its operation in the sharing mode may not be accessible to members of the sharing group. For example, after stopping its operation in the sharing mode, the camera C 316 may have captured visual content while located in the area 306. Such visual content may not be accessible to all members of the sharing group.

The visual information defining the visual content captured by the image sensor 13 during the operation in the sharing mode may be accessible by the members of the sharing group who have stopped the operation in the sharing mode. For example, after the camera C 316 has stopped operating in the sharing mode, the camera A 312 and/or the camera B 314 may capture visual content while operating in the sharing mode. The visual content captured by the cameras 312, 314 while operating in the sharing mode and subsequent to the camera C 316 operating outside the sharing mode may still be accessible to the member (e.g., user/account) of the sharing group associated with the camera C 316. Thus, stopping operating in the sharing mode may not result in loss of access to the shared visual content (visual content captured by image capture device while operating in the sharing mode).

In some implementations, the access of the visual information defining the visual content captured by the image sensor 13 during the operation in the sharing mode by the members of the sharing group (shared visual content) may be limited based on a type of the visual content and/or other information. The type of the visual content may include an image type, a video type, and/or other visual types. The types of the visual content may include types based on quality (e.g., different types based on different resolutions/framerate of visual content), length (e.g., different types based on different lengths of visual content), size (e.g., different types based on different sizes of visuals content), and/or other characteristics of visual content.

Limiting access to the shared visual content based on a type of the visual content may enable hierarchy of access to the shard visual content. For example, certain users (e.g., regular users, users not paying for the sharing service) may be provided with access to shared images but not shared videos, while certain users (e.g., premium users, users paying for the sharing service) may be provided with access to both shared images and shared videos. The hierarchy of access may allow for different access to different types of visual content (based on images/videos, quality, length, size, other characterizes of visual content) to different users. Such hierarchy of access may incentivize users to sign-up/pay for more premium services.

The storage component 106 may be configured to effectuate storage of the visual information defining the visual content captured by the image sensor 13 during the operation in the sharing mode in shared storage media and/or other locations. Shared storage media may refer to storage media from which members of the sharing group may request access to shared visual content. Shared storage media may be included in a single device or across multiple devices (storage media of multiple devices may be used together to provide the shared storage media). In some implementations, shared storage media may be located in a locate remote from the image capture devices, such as a remote server or a remote computer.

In some implementations, the storage component 106 may effectuate storage of the visual information defining the shared visual content during capture of the shared visual content (e.g., live-uploading). In some implementations, the storage component 106 may effectuate storage of the visual information defining the shared visual content after capture of the shared visual content (e.g., during an uploading session).

In some implementations, the storage component 106 may effectuate storage of the visual information defining the shared visual content through one or more mobile devices. For example, referring to FIG. 3B, the storage component 106 of the camera A 312 may effectuate storage of the visual information defining the shared visual content through a mobile device paired with the camera A 312. Images and/or videos captured by the camera A 312 may be (auto) offloaded from the camera A 312 to the mobile device and (auto) uploaded from the mobile device to the shared storage media (e.g., to a remote server).

In some implementations, the visual content stored in shared storage media may be clustered/grouped. The visual content may be clustered based on one or more common characteristics of the visual content. The characteristics of the visual content may include one or of time of capture, location of capture, captured visual (e.g., common subject matter of visual capture), captured audio (e.g., same/similar audio captured), and/or other characteristics.

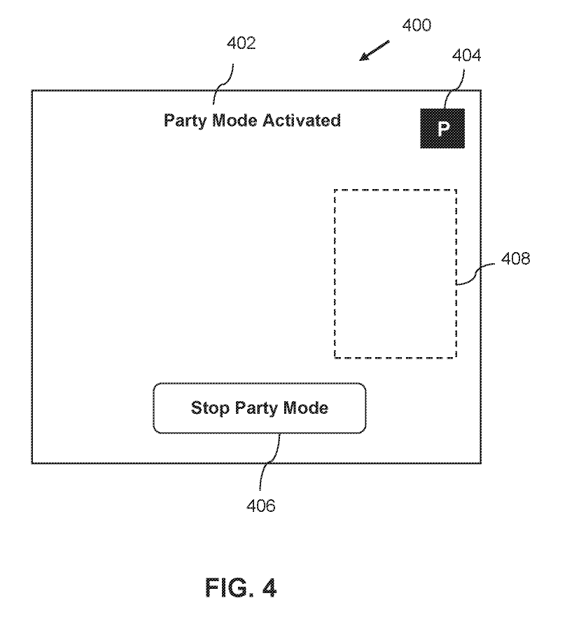

FIG. 4 illustrates an example user interface 400 for sharing captured visual content. Other user interfaces are contemplated. The user interface 400 may be displayed on a display of an image capture device operating in a sharing mode and/or a display of a mobile device paired with such an image capture device. The user interface 400 may indicate that the image capture device is operating in a sharing mode via one or more messages (e.g., a message 402), one or more symbols (e.g., a symbol 404), and/or other displayed information. The user interface 400 may include one or more options (e.g., an option 406) for a user to stop operation in the sharing mode. The user interface 400 may include one or more portions (e.g., a portion 408) that provides information relating to the sharing mode in operation. The portion(s) may display one or more information relating to the sharing mode, such as number of members/image capture devices within the sharing group, the identity of members/image capture devices within the sharing group, how long the image capture device has been operating in the sharing mode, the amount (e.g., number, size) of visual content captured while operating in the sharing mode, and/or other information relating to the sharing mode.

The use of sharing mode as describe herein enables groups of people to easily share visual content they capture with one another (e.g., for a period of time, for an event/trip). By creating an ad-hoc sharing group using a voice command, users are able to easily determine which image capture devices will be used to capture shared visual content, which are stored in shared storage media for access by members of the sharing group. Individuals users are able to stop capturing shared visual content by stopping the operation in the sharing mode, while not losing access to the shared visual content.

In some implementations, visual content may include spherical visual content. Spherical visual content may refer to image/video capture of multiple views from at least one location. Spherical visual content may include a full spherical visual capture (360 degrees of capture) or a partial spherical visual capture (less than 360 degrees of capture). Spherical visual content may be captured through the use of one or more cameras/image sensors to capture images/videos from a location. For spherical visual content captured using multiple cameras/image sensors, multiple images/videos captured by the multiple cameras/image sensors may be stitched together to form the spherical visual content.

Spherical visual content may have been captured at one or more locations. For example, spherical visual content may have been captured from a stationary position (e.g., a seat in a stadium). Spherical visual content may have been captured from a moving position (e.g., a moving bike). Spherical visual content may include image/video capture from a path taken by the capturing device(s) in the moving position. For example, spherical visual content may include video capture from a person walking around in a music festival.

While the present disclosure may be directed to visual content, one or more other implementations of the system may be configured for other types media content. Other types of media content may include one or more of audio content (e.g., music, podcasts, audio books, and/or other audio content), multimedia presentations, images, slideshows, visual content (one or more images and/or videos), and/or other media content.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although the processor 11, the electronic storage 12, the image sensor 13, and the sound sensor 14 are shown to be connected to interface 15 in FIG. 1, any communication medium may be used to facilitate interaction between any components of system 10. One or more components of system 10 may communicate with each other through hard-wired communication, wireless communication, or both. For example, one or more components of system 10 may communicate with each other through a network. For example, processor 11 may wirelessly communicate with electronic storage 12. By way of non-limiting example, wireless communication may include one or more of radio communication, Bluetooth communication, Wi-Fi communication, cellular communication, infrared communication, or other wireless communication. Other types of communications are contemplated by the present disclosure.

Although processor 11 is shown in FIG. 1 as a single entity, this is for illustrative purposes only. In some implementations, processor 11 may comprise a plurality of processing units. These processing units may be physically located within the same device, or processor 11 may represent processing functionality of a plurality of devices operating in coordination. Processor 11 may be configured to execute one or more components by software; hardware; firmware; some combination of software, hardware, and/or firmware; and/or other mechanisms for configuring processing capabilities on processor 11.

It should be appreciated that although computer components are illustrated in FIG. 1 as being co-located within a single processing unit, in implementations in which processor 11 comprises multiple processing units, one or more of computer program components may be located remotely from the other computer program components.

The description of the functionality provided by the different computer program components described herein is for illustrative purposes, and is not intended to be limiting, as any of computer program components may provide more or less functionality than is described. For example, one or more of computer program components 102, 104, 106, 108, and/or 110 may be eliminated, and some or all of its functionality may be provided by other computer program components. As another example, processor 11 may be configured to execute one or more additional computer program components that may perform some or all of the functionality attributed to one or more of computer program components 102, 104, 106, 108, and/or 110 described herein.

The electronic storage media of electronic storage 12 may be provided integrally (i.e., substantially non-removable) with one or more components of system 10 and/or removable storage that is connectable to one or more components of system 10 via, for example, a port (e.g., a USB port, a Firewire port, etc.) or a drive (e.g., a disk drive, etc.). The electronic storage 12 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 12 may be a separate component within system 10, or the electronic storage 12 may be provided integrally with one or more other components of system 10 (e.g., processor 11). Although the electronic storage 12 is shown in FIG. 1 as a single entity, this is for illustrative purposes only. In some implementations, the electronic storage 12 may comprise a plurality of storage units. These storage units may be physically located within the same device, or the electronic storage 12 may represent storage functionality of a plurality of devices operating in coordination.

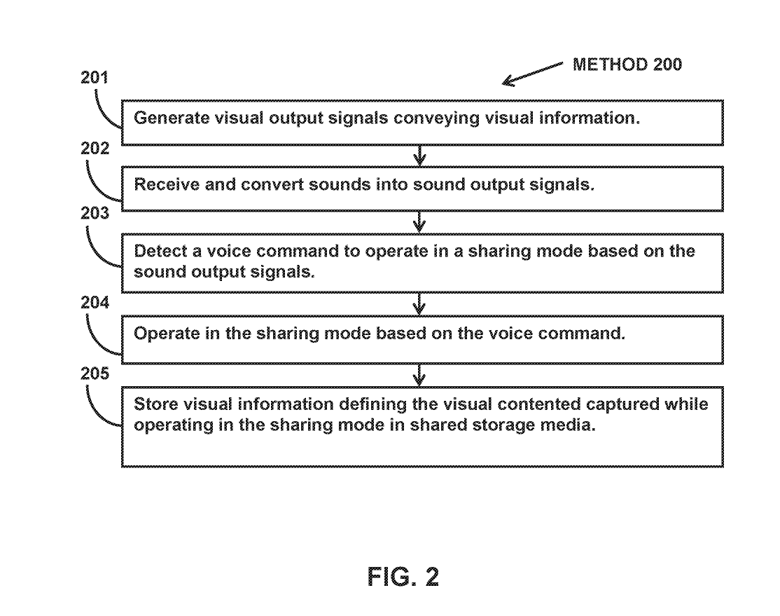

FIG. 2 illustrates method 200 for sharing captured visual content. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operation of method 200 in response to instructions stored electronically on one or more electronic storage mediums. The one or more processing devices may include one or more devices configured through hardware, firmware, and/or software to be specifically designed for execution of one or more of the operation of method 200.

Referring to FIG. 2 and method 200, at operation 201, visual output signals conveying visual information may be generated. The visual information may define visual content based on light received with a field of view of an image sensor. In some implementation, operation 201 may be performed by a component the same as or similar to the image sensor 13 (Shown in FIG. 1 and described herein).

At operation 202, sounds may be received and converted into sound output signals. In some implementations, operation 202 may be performed by a component the same as or similar to the sound sensor 14 (Shown in FIG. 1 and described herein).

At operation 203, a voice command to operate in a sharing mode may be detected based on the sound output signals. In some implementations, operation 203 may be performed by a processor component the same as or similar to the command component 102 (Shown in FIG. 1 and described herein).

At operation 204, a computing system may be operated in the sharing mode based on the voice command. Operating in the sharing mode may cause visual content captured (e.g., by the image sensor 13) while operating in the sharing mode to be accessible to members of a sharing group. Operating outside the sharing mode may cause visual content captured (e.g., by the image sensor 13) while operating outside the sharing mode to not be accessible to the members of the sharing group. In some implementations, operation 204 may be performed by a processor component the same as or similar to the operation component 104 (Shown in FIG. 1 and described herein).

At operation 205, visual information defining the visual content captured while operating in the sharing mode may be stored in shared storage media. In some implementations, operation 205 may be performed by a processor component the same as or similar to the storage component 106 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system for sharing captured visual content, the system comprising:
an image capture device including an image sensor, the image sensor configured to generate visual output signals conveying visual information, the visual information defining visual content based on light received within a field of view of the image sensor;
a sound sensor configured to receive and convert sounds into sound output signals; and
one or more physical processors configured by machine-readable instructions to:
detect a verbal command to operate in a sharing mode based on the sound output signals, wherein the operation of the image capture device and one or more other image capture devices in proximity of the image capture device in the sharing mode is initiated by the verbal command, the image capture device and the one or more other image capture devices forming a device group and users associated with individual image capture devices of the device group forming a sharing group, the operation of the device group in the sharing mode including storage of visual content captured by the individual image capture devices in shared storage media;
operate the image capture device in the sharing mode based on the verbal command until a stop command to stop the operation in the sharing mode is detected, wherein:
the operation of the image capture device in the sharing mode causes visual content captured by the image sensor during the operation in the sharing mode to be accessible to members of the sharing group; and
operation of the image capture device outside the sharing mode causes visual content captured by the image sensor during the operation outside the sharing mode to not be accessible to the members of the sharing group; and
effectuate storage of the visual information defining the visual content captured by the image sensor during the operation in the sharing mode in the shared storage media, the visual information stored in the shared storage media accessible to the members of the sharing group.

2. The system of claim 1, wherein the sharing group is determined based on an audio fingerprint of the verbal command, the audio fingerprint used to identify the individual image capture devices in the device group that received the verbal command.

3. The system of claim 1, wherein the sharing group is determined based on a location and a time of the voice verbal command, the location and the time of the verbal command used to identify the individual image capture devices in the device group that received the verbal command.

4. The system of claim 3, wherein the sharing group is determined further based on proximity of the location and the time of the verbal command to locations and times of the individual image capture devices in the device group.

5. The system of claim 3, further comprising a location sensor, wherein the location of the verbal command is determined based on outputs of the location sensor.

6. The system of claim 3, wherein:
the one or more physical processors are further configured by the machine-readable instructions to communicate with a mobile device, the mobile device including a location sensor; and
the location of the verbal command is determined based on outputs of the location sensor.

7. The system of claim 1, wherein the one or more physical processors are further configured by the machine-readable instructions to:
detect the stop command to stop the operation of the image capture device in the sharing mode; and
stop the operation of the image capture device in the sharing mode based on the stop command;
wherein the visual information stored in the shared storage media is accessible to the members of the sharing group who have stopped the operation of their respective image capture devices in the sharing mode.

8. The system of claim 1, wherein the access of the visual information defining the visual content captured by the image sensor during the operation in the sharing mode by the members of the sharing group is limited based on a type of the visual content.

9. The system of claim 8, wherein the type of the visual content includes an image type or a video type.

10. A method for sharing captured visual content, the method performed by a computing system comprising an image capture device, a sound sensor, and one or more physical processors, the image capture device including an image sensor, the method comprising:
generating, by the image sensor, visual output signals conveying visual information, the visual information defining visual content based on light received within a field of view of the image sensor;
receiving and converting, by the sound sensor, sounds into sound output signals;
detecting, by the computing system, a verbal command to operate in a sharing mode based on the sound output signals, wherein the operation of the image capture device and one or more other image capture devices in proximity of the image capture device in the sharing mode is initiated by the verbal command, the image capture device and the one or more other image capture devices forming a device group and users associated with individual image capture devices of the device group forming a sharing group, the operation of the device group in the sharing mode including storage of visual content captured by the individual image capture devices in shared storage media;
operating, by the computing system, the image capture device in the sharing mode based on the verbal command until a stop command to stop the operation in the sharing mode is detected, wherein:
operating of the image capture device in the sharing mode causes visual content captured by the image sensor while operating in the sharing mode to be accessible to members of the sharing group; and
operating of the image capture device outside the sharing mode causes visual content captured by the image sensor while operating outside the sharing mode to not be accessible to the members of the sharing group; and
effectuating storage of the visual information defining the visual content captured by the image sensor while operating in the sharing mode in the shared storage media, the visual information stored in the shared storage media accessible to the members of the sharing group.

11. The method of claim 10, wherein the sharing group is determined based on an audio fingerprint of the verbal command, the audio fingerprint used to identify the individual image capture devices in the device group that received the verbal command.

12. The method of claim 10, wherein the sharing group is determined based on a location and a time of the verbal command, the location and the time of the verbal command used to identify the individual image capture devices in the device group that received the verbal command.

13. The method of claim 12, wherein the sharing group is determined further based on proximity of the location and the time of the verbal command to locations and times of the individual image capture devices in the device group.

14. The method of claim 12, wherein the computing system further includes a location sensor, and the location of the verbal command is determined based on outputs of the location sensor.

15. The method of claim 12, wherein a mobile device includes a location sensor, and the location of the verbal command is determined based on outputs of the location sensor and communication between the mobile device and the computing device.

16. The method of claim 10, further comprising:
detecting, by the computing system, the stop command to stop the operation of the image capture device in the sharing mode; and
stopping, by the computing system, the operation of the image capture device in the sharing mode based on the stop command;
wherein the visual information stored in the shared storage media is accessible to the members of the sharing group who have stopped the operation of their respective image capture devices in the sharing mode.

17. The method of claim 10, wherein the access of the visual information defining the visual content captured by the image sensor while operating in the sharing mode by the members of the sharing group is limited based on a type of the visual content.

18. The method of claim 17, wherein the type of the visual content includes an image type or a video type.

19. A system for sharing captured visual content, the system comprising:
an image capture device including an image sensor, the image sensor configured to generate visual output signals conveying visual information, the visual information defining visual content based on light received within a field of view of the image sensor;
a sound sensor configured to receive and convert sounds into sound output signals; and
one or more physical processors configured by machine-readable instructions to:
detect a verbal command to operate in a sharing mode based on the sound output signals, wherein the operation of the image capture device and one or more other image capture devices in proximity of the image capture device in the sharing mode is initiated by the verbal command, the image capture device and the one or more other image capture devices forming a device group and users associated with individual image capture devices of the device group forming members of a sharing group, the operation of the device group in the sharing mode including storage of visual content captured by the individual image capture devices in shared storage media;
operate the image capture device in the sharing mode based on the voice verbal command until a stop command to stop the operation in the sharing mode is detected, wherein:
the operation of the image capture device in the sharing mode causes visual content captured by the image sensor during the operation in the sharing mode to be accessible to the members of the sharing group; and
operation of the image capture device outside the sharing mode causes visual content captured by the image sensor during the operation outside the sharing mode to not be accessible to the members of the sharing group;
effectuate storage of the visual information defining the visual content captured by the image sensor during the operation in the sharing mode in the shared storage media, the visual information stored in the shared storage media accessible to the members of the sharing group;
detect the stop command to stop the operation of the image capture device in the sharing mode; and
stop the operation of the image capture device in the sharing mode based on the stop command;
wherein the visual information stored in the shared storage media is accessible to the members of the sharing group who have stopped the operation of their respective image capture devices in the sharing mode.

20. The system of claim 19, wherein the access of the visual information defining the visual content captured by the image sensor during the operation in the sharing mode by the members of the sharing group is limited based on a type of the visual content, the type of the visual content including an image type or a video type.
